(19) United States
(12) Patent Application Publication
(10) Pub. No.: US 2026/0152643 A1
(43) Pub. Date: Jun. 4, 2026

(54) SILICONE COMPOSITION FOR SYNTHETIC LEATHER HAVING ANTIBACTERIAL PROPERTIES AND HIGH WEAR RESISTANCE AND METHOD FOR MANUFACTURING SYNTHETIC LEATHER USING THE SAME

(71) Applicant: Silinol USA, Inc., Irvine, CA (US)

(72) Inventors: Jong-ho Song, Cheongju-si (KR); Do-wan Kweon, Busan (KR); Hyeong-no Kim, Cheongju-si (KR); Seok-hwan Lee, Seongbuk-gu Seoul (KR)

(21) Appl. No.: 19/406,654

(22) Filed: Dec. 2, 2025

(30) Foreign Application Priority Data
Dec. 3, 2024 (KR) 10-2024-0176961

(51) Int. Cl. C09D 5/14; A01N 25/10; A01N 59/00; A01P 1/00; C09D 7/61; C09D 183/04; D03D 15/283; D03D 15/50

(52) U.S. Cl. CPC C09D 5/14; A01N 25/10; A01N 59/00; A01P 1/00; C09D 7/61; C09D 183/04; D03D 15/283; D03D 15/50; D10B 2331/04

(57) ABSTRACT

A silicone composition for synthetic leather having antibacterial properties and high wear resistance, using a coating agent containing an antibacterial agent and silicone resin, and a method for manufacturing synthetic leather using the same. Unlike the prior art in which an addition-reaction type silicone material is used as a coating solution in the manufacture of synthetic leather, a synthetic leather is manufactured by mixing a silicone resin with an ammonium chloride-based antibacterial agent, thereby providing a synthetic leather exhibiting excellent antibacterial properties and wear resistance. As a result, it becomes possible to produce and provide an optimized synthetic leather suitable for a variety of applications.

### PRIORITY AND INCORPORATION BY REFERENCE

This application claims the benefit of Korean Application No. 10-2024-0176961, filed Dec. 3, 2024, pending, the entirety of which is incorporated by reference herein and made a part of the present disclosure. Any and all applications for which a foreign or domestic priority claim is identified in connection with the present application are hereby incorporated by reference herein and made a part of the present disclosure.

### BACKGROUND

### 1. Field of the Invention

The present invention relates to the field of synthetic leather, and more specifically, to a silicone composition for synthetic leather having antibacterial properties and high wear resistance, using a coating agent containing an antibacterial agent and silicone resin, and to a method for manufacturing synthetic leather using the same.

### 2. Description of Related Art

Generally, synthetic leather is widely used for interior materials of transportation means such as automobiles, ships, and railways, as well as for furniture, accessories, and various types of interior finishing.

The manufacture of synthetic leather as described above involves using materials such as polyurethane or PVC, wherein a coating solution like polyurethane is coated and dried on a release liner, followed by coating with adhesives or curing agents, bonding and curing a fabric onto the coated surface before peeling off the release liner, or alternatively impregnating the fabric with a polyurethane-based impregnation liquid, coagulating in a coagulation bath, coating with a polyurethane-based coating solution, coagulating and drying again in the coagulation bath, and then performing post-processing such as embossing.

Synthetic leather manufactured by the above method has many problems, including toxicity from the use of polyurethane, difficulty in disposal, poor dimensional stability, thermal decomposition at high temperatures, weak hydrolysis resistance, and poor stain resistance.

In addition to the numerous problems associated with conventional synthetic leather manufacturing methods as described above, there has been an increasing demand for synthetic leather with high-performance properties such as anti-fouling and eco-friendliness to prevent environmental pollution, which has led to the development of manufacturing technologies for silicone synthetic leather using environmentally friendly silicone materials that do not employ organic solvents.

In the case of silicone synthetic leather recently introduced and produced by the above methods, enhanced physical properties have become necessary not only to meet demand for eco-friendliness on the market but also to accommodate a wide range of applications such as transportation, furniture, accessories, and interior use.

Meanwhile, silicone materials are generally classified into silicone oils composed of linear low-molecular-weight compounds, linear silicone elastomers composed of high-molecular-weight polymers (LSR and HCR types), and silicone resins that form a network structure after curing and drying.

In addition, silicone coatings used in synthetic leather manufacturing typically employ linear silicone rubbers such as LSR (liquid silicone rubber) or HCR (heat-cured rubber), as shown in Table 1 below; these are mostly produced through addition reaction curing using a platinum catalyst, and to reinforce properties such as wear resistance, higher molecular weight linear silicone rubbers are selected within the processable viscosity range for application and production (the higher the number n in Table 1, the greater the molecular weight of the silicone rubber).

### Table 1

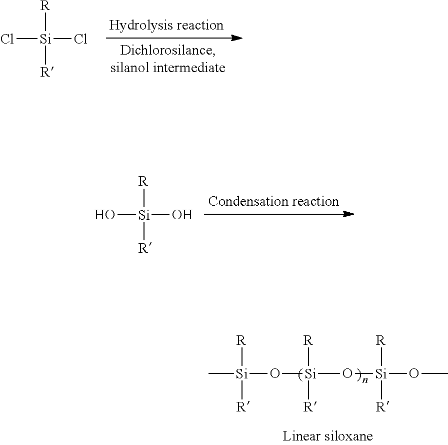

Although silicone materials inherently contain inorganic components that provide a certain level of antibacterial properties, achieving effective antibacterial performance against organisms such as pneumococcus (pneumococcus), staphylococcus (staphylococcus), and pink stain (pink stain) bacteria is difficult, and because (zinc) zinc-based antibacterial agents commonly used for such purposes interfere with the curing of silicone due to the inherent properties of the material, it is important to develop a method that imparts antibacterial functionality without hindering the curing process; however, research on securing antibacterial properties in synthetic leather using conventional silicone materials has been minimal.

In the field of synthetic leather manufacturing to which the present invention pertains, numerous technological developments have been made to address the aforementioned needs and to overcome the disadvantages associated with synthetic leather.

For example, Korean Registered Patent No. 10-1381914 (registered on Mar. 31, 2014) discloses a method for manufacturing synthetic leather and the synthetic leather manufactured thereby, wherein different types of liquid silicone rubber are coated onto a fabric made of heat-resistant fibers such as aramid or OPF as the base material to satisfy specifications for vertical flame retardancy, smoke density, and heat release applicable to aircraft or ship interior materials, or onto a microfiber nonwoven fabric as the base material to impart flame retardancy, heat resistance, anti-soiling, chemical resistance, and hydrolysis resistance, making it suitable for automotive, various interior, and miscellaneous goods applications.

Another example, Korean Registered Patent No. 10-1565389 (registered on Oct. 28, 2015), discloses a method for manufacturing a substrate using a silicone resin coating solution containing microspheres, in order to reproduce the texture of natural leather and reduce production costs in the manufacturing of synthetic leather, thereby enabling its application to various furniture and household products.

Additionally, Korean Registered Patent No. 10-1789887 (registered on Oct. 18, 2017) discloses a method for manufacturing silicone synthetic leather using silicone rubber, wherein the method involves primary coating a surface treatment agent onto a release liner followed by coating the main coating agent, thereby eliminating the additional surface treatment step after peeling to reduce costs, and enabling improved adhesion by coating both the surface treatment agent and the main coating agent in a single process, which is an advantageous method for producing silicone synthetic leather.

Another example, Korean Registered Patent No. 10-2052464 (registered on Nov. 29, 2019), discloses a coating solution for synthetic leather and a manufacturing method using the same, wherein the conventional process involving two or more coating steps is simplified into a single coating step, thereby enabling the economical and efficient production of synthetic leather while improving wear resistance and reducing surface peeling.

### SUMMARY

However, the conventional art described above differs significantly from the present invention, which is directed toward the manufacture of synthetic leather having both antibacterial properties and high wear resistance.

Unlike the conventional art described above, one or more embodiments of the present invention aim to provide a synthetic leather exhibiting antibacterial properties and high wear resistance as required under current conditions, by incorporating an antimicrobial agent compatible with silicone materials to ensure antibacterial efficacy, while integrating a network-structured, more robust silicone resin into the coating solution to maintain the inherent softness of the synthetic leather and simultaneously impart high wear resistance; accordingly, one or more embodiments of the present invention provide a silicone composition and a method for manufacturing synthetic leather using the same.

One or more embodiments of the present invention, in order to achieve the above-mentioned objectives, provide a silicone composition for synthetic leather having antibacterial properties and high wear resistance, containing a primary coating solution to be coated on a release liner, a secondary coating solution coated on the primary coating solution, and a tertiary coating solution coated on the secondary coating solution serving as a binder.

The primary coating solution described above preferably includes, relative to 100 parts by weight of liquid silicone rubber (LSR) having a Shore hardness (Shore A) of 50 to 80 and an elongation of 300 to 600%: 10 to 500 parts by weight of a silicone resin containing 40% silicone resin and 60% vinyl functional groups; 0.2 to 60 parts by weight of a silicone curing agent; 0.1 to 60 parts by weight of a platinum catalyst; 0.2 to 15 parts by weight of a reaction inhibitor; 10 to 100 parts by weight of a silicone polymer; and 2 to 40 parts by weight of an antimicrobial agent.

In the above, the LSR preferably has vinyl functional groups (vinyl functional group) and methyl hydrogen functional groups (methyl hydrogen group).

In addition, the silicone curing agent preferably contains methyl hydrogen functional groups (methyl hydrogen group), the silicone polymer is preferably of low viscosity and has vinyl functional groups, and the antimicrobial agent is preferably an ammonium chloride-based antimicrobial agent.

The secondary coating solution preferably includes, relative to 100 parts by weight of LSR having a Shore hardness (Shore A) of 30 to 70 and an elongation of 200 to 700%: 5 to 50 parts by weight of a low-viscosity silicone polymer; 0.2 to 60 parts by weight of a silicone curing agent; 0.1 to 60 parts by weight of the platinum catalyst; 0.2 to 15 parts by weight of the reaction inhibitor; and 2 to 30 parts by weight of a toner.

In the above, the LSR is an addition-curable silicone containing vinyl functional groups, preferably having an average molecular weight of 100,000 to 700,000, and the LSR may contain a curing agent, reaction inhibitor, fillers such as silica, and a platinum catalyst.

The tertiary coating solution, which serves as a binder, may be prepared similarly to the secondary coating solution considering coating processability, and preferably contains, relative to 100 parts by weight of LSR (liquid silicone rubber) that is addition-curable, contains vinyl functional groups, has a weight average molecular weight of 100,000 to 700,000, a Shore hardness (Shore A) of 20 to 80, and an elongation of approximately 200 to 700%: 5 to 50 parts by weight of the low-viscosity silicone polymer having a vinyl functional group; 0.2 to 60 parts by weight of the silicone curing agent having a methyl hydrogen functional group; and 2 to 30 parts by weight of a toner.

In the above, the LSR (liquid silicone rubber) may use, as the base resin, a formulation containing a curing agent, reaction inhibitor, fillers such as silica, and a platinum catalyst.

Further, to achieve another objective of the present invention, a method for manufacturing synthetic leather using the aforementioned silicone compositions is provided.

The method for manufacturing synthetic leather using the silicone composition having antibacterial properties and high wear resistance includes:
a step S1 for coating the primary coating solution onto a release liner at a thickness of 2 to 50 μm, followed by curing and drying;
a step S2 for coating the secondary coating solution onto the layer formed in step S1 at a thickness of 10 to 60 μm, followed by curing and drying;
a step S3 for coating the tertiary coating solution onto the layer formed in step S2 at a thickness of 10 to 80 μm; and
a step S4 for laminating and compressing a fabric onto the coated layer from step S3, followed by curing and drying.

In the above, the curing and drying processes in steps S1, S2, and S4 are preferably carried out at a temperature of 130 to 150° C. for 3 to 5 minutes, respectively.

In addition, the fabric used in step S4 is preferably woven from one or more selected from 75-denier/36-filament polyester yarn, 30-denier/12-filament shrinkable yarn, and 144-filament polyester yarn, and has a basis weight in the range of 250 to 500 g/m2.

In addition, the fabric may be woven using a composition by weight of 20 to 60% 75-denier/36-filament polyester yarn, 5 to 30% 30-denier/12-filament high-shrinkage yarn, and 35 to 75% 75-denier/144-filament polyester yarn.

According to one or more embodiments of the present invention, unlike the prior art in which an addition-reaction type silicone material is used as a coating solution in the manufacture of synthetic leather, a synthetic leather is manufactured by mixing a silicone resin with an ammonium chloride-based antibacterial agent, thereby providing a synthetic leather exhibiting excellent antibacterial properties and wear resistance. As a result, it becomes possible to produce and provide an optimized synthetic leather suitable for a variety of applications.

### BRIEF DESCRIPTION OF THE DRAWINGS

These and other features of the inventions disclosed herein are described below with reference to the drawings of one or more embodiments, which are intended to illustrate, but not to limit, the inventions. The drawings contain the following figures.

FIG. 1 is a schematic diagram illustrating a method for manufacturing synthetic leather using a knife coating process.

FIG. 2 is a schematic diagram illustrating a method for manufacturing synthetic leather using a combination of knife coating and roll coating processes.

FIG. 3 is a schematic diagram of the synthetic leather produced by the method illustrated in FIG. 1.

FIG. 4 is a schematic diagram of the synthetic leather produced by the method illustrated in FIG. 2.

### DETAILED DESCRIPTION

Hereinafter, the present invention will be described in greater detail with reference to preferred embodiments.

The following description is provided to aid in the understanding and implementation of the present invention and is not intended to limit the scope of the invention.

Those skilled in the art will understand that various modifications, alterations, or changes may be made within the spirit and scope of the present invention as defined by the following claims.

Furthermore, the terminology used in this specification is employed solely for the purpose of describing the invention and is not intended to limit the invention thereto; unless clearly indicated otherwise by the context, singular expressions include their plural counterparts.

Additionally, the terms such as “primary” and “secondary” used in the present invention may be employed to describe various components but should not be construed as limiting these components to the numerical order indicated by such terms.

The above terms are used solely for the purpose of distinguishing one component from other components.

The present invention fundamentally provides the technical concept of a silicone composition exhibiting antibacterial properties and high wear resistance through the use of an antimicrobial agent, as well as a method for manufacturing synthetic leather using the same.

Hereinafter, detailed descriptions are provided regarding the synthetic leather composition of the present invention, the coating of the composition, the fabric laminated onto the coated surface, and the processing methods thereof.

The silicone resin applied in the present invention, unlike the linear curing structures of conventional LSR and HCR, is cured into a network structure as shown in Table 2, forming a hard film upon curing and thereby serving as a heat-resistant varnish (varnish) for electrical insulation, a base resin for heat- and weather-resistant coatings, molding materials, and release applications.

### Table 2

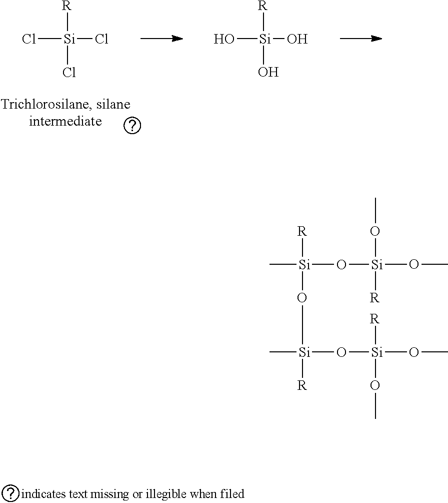

In addition, the silicone material employed in the present invention incorporates a silicone material having an addition reaction curing method, as shown in Table 3 below.

### Table 3

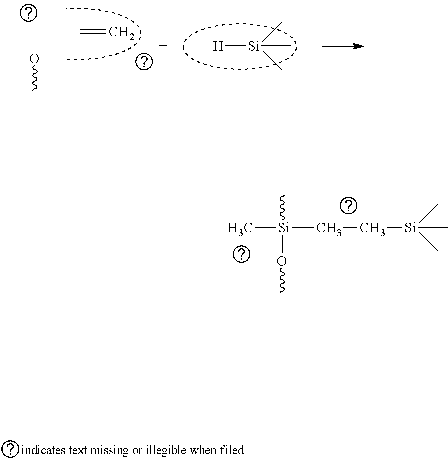

### Primary Coating Solution

The primary coating solution, which forms the top coating layer, is prepared by mixing an addition-curable silicone rubber with a silicone resin and an antimicrobial agent.

The primary coating solution is a mixed composition containing, relative to 100 parts by weight of liquid silicone rubber (LSR) having vinyl functional groups (vinyl functional group) and methyl hydrogen functional groups (methyl hydrogen group), a Shore hardness (Shore hardness: Shore A) of 50 to 80, and an elongation of 300 to 600%: 10 to 500 parts by weight of a silicone resin containing 40% silicone resin and 60% vinyl-functional silicone rubber by weight; 0.2 to 60 parts by weight of a silicone curing agent containing methyl hydrogen functional groups; 0.1 to 60 parts by weight of a platinum catalyst; 0.2 to 15 parts by weight of a reaction inhibitor; 10 to 100 parts by weight of a low-viscosity silicone polymer having vinyl functional groups; and 2 to 40 parts by weight of an ammonium chloride-based antimicrobial agent.

The silicone resin used herein is of a type possessing addition-reactive vinyl functional groups, which react with methyl hydrogen functional groups (methyl hydrogen group) to increase the curing density and thereby enhance the wear resistance of the primary coating solution.

### Table 4

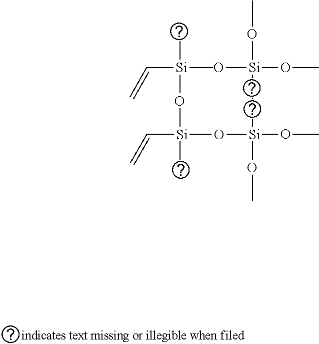

Additionally, the methyl hydrogen functional groups (methyl hydrogen group) added to the primary coating solution are mainly of the type having side-chain functional groups (Table 5), and for hardness adjustment, a curing agent with terminal methyl hydrogen functional groups (Table 6) may be further mixed; the amount used varies from 0.2 to 60 parts by weight depending on the content of the silicone resin applied.

### Table 5

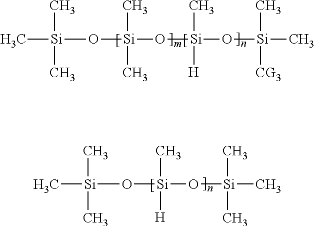

(Type with Methyl Hydrogen Functional Group on the Side)

### Table 6

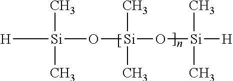

(Type with Methyl Hydrogen Functional Groups at Both Ends)

Additionally, the ammonium chloride antimicrobial agent (Table 7) mixed into the primary coating solution and surface treatment solution is an inorganic compound widely used across various industries, including medical and food applications, and is incorporated in an amount of 2 to 40 parts by weight.

### Table 7

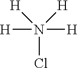

### (Ammonium Chloride)

Additionally, the platinum catalyst and reaction inhibitor are conventional types commonly used in silicone addition reactions, and their application was adjusted according to the content of the vinyl-functional silicone resin and curing agent mixed.

### Secondary Coating Solution

The secondary coating solution used in the present invention is a mixed composition containing 100 parts by weight of addition-curable liquid silicone rubber (LSR) possessing vinyl functional groups, having a weight-average molecular weight of 100,000 to 700,000, a Shore hardness (Shore A) of 30 to 70, and an elongation of approximately 200 to 700%, wherein the silicone rubber used may include a base resin containing curing agents, reaction inhibitors, fillers such as silica, and platinum catalysts; to enhance processability, the composition further includes 5 to 50 parts by weight of a low-viscosity silicone polymer having a vinyl functional group, 0.2 to 60 parts by weight of a silicone curing agent having a methyl hydrogen functional group for curing the low-viscosity vinyl-functional polymer, 0.1 to 60 parts by weight of a platinum catalyst, 0.2 to 15 parts by weight of a reaction inhibitor, and 2 to 30 parts by weight of a toner for coloration.

### Tertiary Coating Solution

The tertiary coating solution in the present invention can be prepared similarly to the secondary coating solution, considering coating processability, and consists of 100 parts by weight of addition-curable liquid silicone rubber (LSR) having vinyl functional groups, a weight-average molecular weight of 100,000 to 700,000, a Shore hardness (Shore A) of 20 to 80, and an elongation of approximately 200 to 700%, wherein the silicone rubber used may serve as a base resin containing curing agents, reaction inhibitors, fillers such as silica, and platinum catalysts; additionally, the composition includes 5 to 50 parts by weight of the low-viscosity silicone polymer having a vinyl functional group for enhanced processability, 0.2 to 60 parts by weight of the silicone curing agent having a methyl hydrogen functional group for curing the low-viscosity vinyl-functional polymer, 0.1 to 60 parts by weight of the platinum catalyst, 0.2 to 15 parts by weight of the reaction inhibitor, and 2 to 30 parts by weight of a toner for coloration.

The tertiary coating solution uses a type with a relatively lower Shore hardness (Shore A) than the secondary coating solution, considering the softness (softness) of the final product.

The tertiary coating solution is prepared by mixing the silicone rubber using a roll mill or mixer, thereby promoting the curing of the silicone rubber through an addition-curing reaction; furthermore, fillers, curing agents, reaction inhibitors, and platinum catalysts are added to enhance physical properties such as heat resistance, flame retardancy, surface feel, and wear resistance of the silicone rubber, along with pigments for color realization.

The coating solutions used in the present invention contain silicone rubber, curing agents, reaction inhibitors, fillers, pigments, and platinum catalysts; the silicone rubber has vinyl functional groups, a weight-average molecular weight of 100,000 to 700,000, a Shore hardness (Shore A) of 40 to 80, and an elongation of approximately 300 to 600%.

The silicone rubber described above is selected in consideration of the mechanical properties such as wear resistance required for the synthetic leather to be manufactured, and preferably uses dimethylsiloxane and dimethylvinyl-terminated silicone.

Using the aforementioned silicone rubber, the coating solution is prepared by mixing while promoting the curing of the silicone rubber through an addition-curing reaction; fillers, curing agents, reaction inhibitors, and platinum catalysts are added to enhance physical properties such as heat resistance, flame retardancy, surface feel, and wear resistance of the silicone rubber, along with pigments for color realization.

In one or more embodiments of the present invention, the coating solution is prepared by adding and milling 1 to 5 parts by weight of curing agent, 0.5 to 3 parts by weight of reaction inhibitor, 0.1 to 5 parts by weight of filler, 2 to 20 parts by weight of pigment, and 0.1 to 5 parts by weight of platinum catalyst relative to 100 parts by weight of the silicone rubber to achieve uniform dispersion.

In the above, the reaction inhibitor is a cure inhibitor, the curing agent is dimethyl, methylhydrogen siloxane, and the filler is one or more selected from trimethylated silica, dimethylvinylated and trimethylated silica, alumina hydrate, and titanium dioxide.

The curing agent is for curing the silicone resin, and when the amount is too low, curing may be too slow or incomplete, while when it is too high, curing may occur too quickly before post-processing, which is undesirable, so it is contained within the above range.

The reaction inhibitor is used to secure an adequate working time, as excessively rapid curing of the silicone may adversely affect subsequent processes; insufficient addition renders no effect, whereas excessive addition results in excessively slow curing, leading to mismatched working times, which is undesirable; therefore, the inhibitor is used within the specified range.

In addition, the filler is used to improve physical properties such as heat resistance, flame retardancy, surface touch, and wear resistance of the coating applied to the synthetic leather, and when used in an excessively small amount, no additional effect is obtained while economic efficiency is reduced; therefore, it is preferable to use the filler within the above-mentioned range.

### Fabric

The fabric used in the present invention is a warp-knitted fabric woven using one or more of polyester 75-denier 36-filament yarn, 30-denier 12-filament high-shrinkage yarn, and polyester 75-denier 144-filament yarn, and has a weight of 250 to 500 g/m2.

When weaving the fabric by combining the three types of yarns described above, it is preferable to compose the fabric such that the 75-denier 36-filament yarn is contained in an amount of about 20 to 60 wt %, the 30-denier 12-filament high-shrinkage yarn in an amount of about 5 to 30 wt %, and the 75-denier 144-filament yarn in an amount of about 35 to 75 wt %.

The reason for this configuration is that the 75-denier 35-filament yarn is used to improve adhesion with the coating material in fabrics woven with yarns of lower softness; however, when its content is too low, adhesion decreases, and when used excessively, the fabric becomes too stiff, compromising its function as synthetic leather, and thus reducing the use of the softer 75-denier 144-filament yarn becomes necessary, making the stated composition preferable.

In addition, the high-shrinkage yarn is used to secure the stretchability of the synthetic leather and to increase the fabric density through shrinkage during processing, thereby enabling the production of a fabric with enhanced tactile and aesthetic properties.

Accordingly, the fabric having the above-described structure is optimized for ensuring the desired tactile and aesthetic properties, as well as consistent elongation and strength required for synthetic leather. The weight of 250 to 500 g/m2 is employed to balance economic feasibility and performance, as the appropriate fabric weight may vary depending on the application field of the synthetic leather, such as furniture, fashion accessories, interior materials, or interior components of vehicles and aircraft.

### Manufacturing of Synthetic Leather

### Step S1: Primary Coating

The manufacturing process of the synthetic leather of the present invention will now be described using the coating solutions as outlined above.

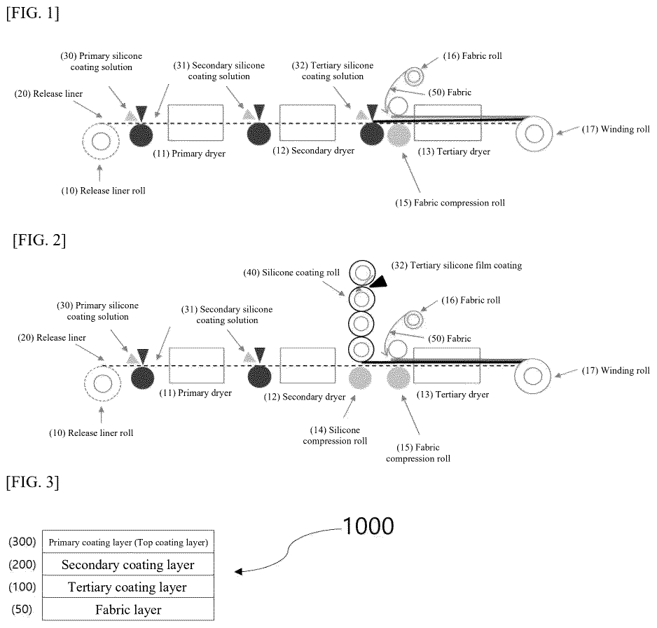

First, FIG. 1 is a schematic diagram illustrating a method for manufacturing synthetic leather using a knife coating method, and FIG. 2 is a schematic diagram illustrating a method for manufacturing synthetic leather by combining the knife coating method with a roll coating method.

First, as illustrated in FIGS. 1 and 2, a release film 20 supplied from a release film supply roll 10 is coated with the prepared primary coating solution 30, wherein the coating is performed using a conventional knife coating method at a thickness of 2 to 50 μm.

When the coating thickness is less than 2 μm, surface wear resistance decreases, and when it exceeds 50 μm, it is economically unreasonable and adversely affects the texture of the product; therefore, coating is performed within the above range.

After coating, curing and drying are performed in the primary dryer 11 at a temperature of approximately 130 to 150° C. for about 3 to 5 minutes.

When the temperature is less than or equal to 130° C. or the drying time is less than or equal to 3 minutes, the curing and drying of the primary coating layer may be incomplete, causing issues during the secondary coating; conversely, when the temperature is more than or equal to 150° C. or the time is more than or equal to 5 minutes, excessive processing time may be required, leading to reduced productivity and possibly causing slight charring beyond curing, and therefore the above conditions are maintained.

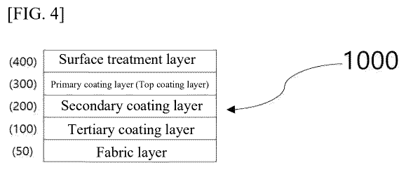

The primary coating layer 300, which is the top coating layer shown in FIGS. 3 and 4, is completed through the above process.

### Step S2: Secondary Coating

On the surface after completing the primary coating in step S1, a secondary coating is applied using the prepared secondary coating solution 31, with a coating thickness of 10 to 60 μm, followed by curing and drying in the secondary dryer 12 to form the secondary coating layer 200 shown in FIGS. 3 and 4.

The reason for setting the coating thickness to 10 to 60 μm is that when the secondary coating is less than or equal to 10 μm, wear resistance is weakened, resulting in reduced product quality and failure to achieve the high wear resistance intended by the present invention, while coating thicknesses is more than or equal to 60 μm are economically inefficient and may deteriorate the tactile properties of the final product due to excessive curing thickness; therefore, the coating is applied within the above range.

Also, curing and drying after coating with the secondary coating solution 31 is performed at 130 to 150° C. for about 3 to 5 minutes, for the same reasons as described for the primary coating.

In the case of the secondary coating, considering the final product's tactile properties, consumer demands, and economic efficiency, the tertiary coating may be applied immediately after the secondary coating.

The secondary coating layer (200) is completed as described above.

### Step S3: Tertiary Coating

A tertiary coating is applied to the surface that has undergone secondary coating and curing/drying in step S2.

The tertiary coating is performed using the prepared tertiary coating solution 32 or tertiary silicone film coating solution 32′, with a coating thickness of approximately 10 to 80 μm.

The above coating thickness is set because the tertiary coating acts as a binder with the fabric 50; when it is less than 10 μm, problems may arise in bonding with the fabric 50, and when it exceeds 80 μm, excessive absorption into the fabric 50 may cause the exterior of the synthetic leather to appear defective.

Therefore, the tertiary coating solution 32 and the tertiary silicone film coating solution 32′, which serve as binders during the subsequent lamination with the fabric 50, are coated at the above thickness to sufficiently penetrate the fabric 50 and facilitate subsequent compressing and curing/drying.

### Step S4: Fabric Combination

In the above step S3, the fabric 50 supplied from the fabric roll 16 is laminated onto the coated surface of the tertiary coating solution 32 or tertiary silicone film coating solution 32′, then compressed through the fabric compression roll 15, and subsequently cured and dried through the tertiary dryer 13.

The synthetic resin 1000, completed by bonding the fabric layer 50 as described above, is wound through the winding roll 17.

The curing and drying in step S4 are carried out in the same manner as in steps S1 and S2, for the same reasons as described in those steps.

The coating of the tertiary coating solution 31 may be performed using a knife coating method as shown in FIG. 1, or by a calendering method as illustrated in FIG. 2.

When the calendering method as shown in FIG. 2 is used, the silicone material of the tertiary silicone film coating solution 32′ may be a linear, addition-curable high-viscosity silicone rubber.

After the tertiary coating, lamination with the fabric, and curing/drying, the release liner 20 is peeled off to obtain the cross-section illustrated in FIG. 3, and to improve the surface touch and adjust the gloss of the primary coating layer 300, a surface treatment layer 400 as illustrated in FIG. 4 may be formed using, for example, the method disclosed in KR 10-2016-0068353, or by preparing a surface treatment layer 400 containing 1 to 50 parts by weight of an ammonium chloride-based antibacterial agent and applying it via a gravure coating method.

### Example 1

### Fabric Preparation

As described above, a warp-knitted fabric having a weight of approximately 270 g/m² was prepared by combining, by weight, about 25% polyester 75-denier 36-filament yarn, about 10% 30-denier 12-filament high-shrinkage yarn, and about 65% polyester 75-denier 144-filament yarn.

### Manufacturing of Primary Coating Solution

The primary coating solution was prepared and used by mixing an addition-reaction type silicone rubber with a silicone resin and an antimicrobial agent.

A coating solution was prepared by mixing: 100 parts by weight of LSR (liquid silicone rubber) having vinyl functional groups (vinyl functional group) and methyl hydrogen functional groups (methyl hydrogen group), with a shore hardness (Shore A) of 70 and an elongation of 400%; 200 parts by weight of a silicone resin containing 40% silicone resin and 60% vinyl functional groups; 50 parts by weight of a silicone curing agent containing methyl hydrogen functional groups (methyl hydrogen group); 3 parts by weight of a platinum catalyst; 1.1 parts by weight of a reaction inhibitor; 20 parts by weight of a low-viscosity silicone polymer having vinyl functional groups; and 20 parts by weight of an ammonium chloride-based antimicrobial agent.

### Manufacturing of Secondary Coating Solution

A secondary coating solution was prepared by mixing 100 parts by weight of addition reaction type silicone having vinyl functional groups (vinyl functional group), a weight average molecular weight of approximately 400,000, a shore hardness (Shore A) of 50, and an elongation of about 500% in the form of LSR (liquid silicone rubber); the silicone rubber used herein contains curing agent, reaction inhibitor, silica filler, and platinum catalyst; 20 parts by weight of a low-viscosity silicone polymer having vinyl functional groups for processability; 10 parts by weight of a silicone curing agent containing methyl hydrogen functional groups (methyl hydrogen group) to cure the low-viscosity vinyl functional group; 2 parts by weight of platinum catalyst; 2 parts by weight of reaction inhibitor; and 15 parts by weight of toner for coloration.

### Manufacturing of Tertiary Coating Solution

The tertiary coating solution applied in the knife coating method of FIG. 1 includes 100 parts by weight of addition reaction type silicone having vinyl functional groups, a weight average molecular weight of 400,000, a shore hardness (Shore A) of 40, and an elongation of 600% in the form of LSR (liquid silicone rubber); the silicone rubber used herein is employed as a base resin containing curing agent, reaction inhibitor, silica filler, and platinum catalyst.

For processability, 10 parts by weight of low-viscosity silicone polymer with vinyl functional groups; 10 parts by weight of silicone curing agent containing methyl hydrogen groups to cure the low-viscosity vinyl functional groups; 2 parts by weight of platinum catalyst; 2 parts by weight of reaction inhibitor; and 10 parts by weight of toner for coloration were mixed to prepare the tertiary coating solution.

The tertiary coating solution used in the calendering method as illustrated in FIG. 2 includes 100 parts by weight of liquid silicone rubber having a weight average molecular weight of approximately 600,000, a shore hardness (Shore A) of 50, and an elongation of about 500%; to which 3 parts by weight of curing agent, 0.5 parts by weight of reaction inhibitor, 10 parts by weight of toner, and 0.2 parts by weight of platinum catalyst were added and milled to achieve uniform dispersion.

### Manufacturing of Synthetic Leather

The prepared primary coating solution was knife-coated onto the release liner at a thickness of 15 μm and cured, followed by knife coating and curing of the secondary coating solution at a thickness of 25 μm, and then the tertiary coating solution 32, which serves as a binder for adhesion between the primary and secondary coating layers and the fabric, was coated by knife or calendering method at a thickness of 50 μm, after which the fabric was laminated, compressed, cured, and dried, and then the release liner was peeled off to produce synthetic leather coated with silicone rubber.

### Surface Treatment

The synthetic leather manufactured as described above was surface-treated with a conventional synthetic leather surface treatment agent at a temperature of 130° C. using a 100-mesh gravure coater to form a coating layer with a thickness of 6 μm, in order to control surface properties and texture.

### Comparison Example 1

### Fabric Preparation

The fabric manufactured in Example 1 was used.

### Primary Coating Solution Preparation

A coating solution excluding the silicone resin from the primary coating solution of Example 1 was mixed and used,

A mixture was prepared by combining 100 parts by weight of LSR (liquid silicone rubber) having vinyl functional groups (vinyl functional group) and methyl hydrogen functional groups (methyl hydrogen group), a shore hardness (Shore A) of 70, and an elongation of 400%; 20 parts by weight of a low-viscosity silicone polymer containing vinyl functional groups; and 20 parts by weight of ammonium chloride antimicrobial agent.

### Secondary Coating Solution Preparation

The same coating solution as in Example 1 was used.

### Tertiary Coating Solution Preparation

The same coating solution as in Example 1 was used.

### Manufacturing of Synthetic Leather

The same processing method as in Example 1 was applied.

### Surface Treatment

The same processing method as in Example 1 was applied.

### Comparison Example 2

### Fabric Preparation

The fabric manufactured in Example 1 was used.

### Primary Coating Solution Preparation

A coating solution was prepared and used by mixing the primary coating solution of Example 1 excluding the resin and antimicrobial agent.

A coating solution was prepared by mixing 100 parts by weight of LSR (liquid silicone rubber) having vinyl functional groups (vinyl functional group) and methyl hydrogen functional groups (methyl hydrogen group), a Shore hardness (Shore A) of 70, and an elongation of 400%, with 20 parts by weight of a low-viscosity silicone polymer having a vinyl functional group.

### Secondary Coating Solution Preparation

The same coating solution as in Example 1 was used.

### Tertiary Coating Solution Preparation

The same coating solution as in Example 1 was used.

### Manufacturing of Synthetic Leather

The same processing method as in Example 1 was used.

### Surface Treatment

The same processing method as in Example 1 was applied.

For the synthetic leather products manufactured according to Example 1 and Comparative Examples 1 and 2, the wear resistance and antibacterial performance were evaluated using the evaluation methods shown in Table 8 below, in order to determine the commercial suitability of the synthetic leather of the present invention.

### Table 8

TABLE 8

| | | Display evaluation results | |
|---|---|---|---|
| Item | Evaluation method | (number of times or series) | Remarks |
| Wear resistance | ASTM 4157-02 | Number of times | The higher the better |
| Antibacterial | ASTM E1428 | 0 to 4 | The lower the better |
| properties | | | |

The results are as shown in Table 9 below.

### Table 9

TABLE 9

| | | Characteristic values of | |
|---|---|---|---|
| | | synthetic leather | |
| | | | Antibacterial |
| Category | Contents | Wear resistance | properties |
| Example 1 | Silicone rubber + resin + | 200,000 | 0 to 1 |
| | antibacterial agent | | |
| Comparative | Silicone rubber + | 20,000 to 50,000 | 0 to 1 |
| Example 1 | antibacterial agent | | |
| Comparison | Silicone rubber | 20,000 to 50,000 | 4 |
| Example 2 | | | |

As shown in Table 9, the synthetic leather according to Example 1 of the present invention exhibited excellent wear resistance and antibacterial properties, whereas Comparative Examples 1 and 2, which did not contain silicone resin, showed significantly lower wear resistance, and Comparative Example 2, which lacked antibacterial agent, demonstrated reduced antibacterial performance.

Therefore, the composition of the present invention and the synthetic leather manufactured using the same exhibit high wear resistance and excellent antibacterial properties, making them effectively applicable for practical use.

While several embodiments are presented in the foregoing detailed description, a vast number of variations exist. The embodiments described herein are not intended to limit the scope, applicability, or configuration of the claimed subject matter in any way. Rather, the foregoing detailed description provides those skilled in the art with a convenient road map for implementing the described embodiments. Various changes can be made in the function and arrangement of elements without departing from the scope defined by the claims, which includes known equivalents and foreseeable equivalents at the time of filing this patent application.

What is claimed is:

1. A silicone composition for synthetic leather having antibacterial properties and high wear resistance, comprising:
a primary coating solution for forming a primary coating layer;
a secondary coating solution for forming a secondary coating layer on the primary coating layer; and
a tertiary coating solution for forming a tertiary coating layer on the secondary coating layer;
wherein the primary coating solution comprises:
100 parts by weight of liquid silicone rubber (LSR) having a vinyl functional group and a methyl hydrogen functional group, with a Shore hardness (Shore A) of 50 to 80 and an elongation of 300 to 600%;
10 to 500 parts by weight of a silicone resin containing 40 wt % of silicone resin and 60 wt % of silicone rubber having a vinyl functional group;
0.2 to 60 parts by weight of a silicone curing agent having a methyl hydrogen functional group;
0.1 to 60 parts by weight of a platinum catalyst;
0.2 to 15 parts by weight of a reaction retarder;
10 to 100 parts by weight of a low-viscosity silicone polymer having a vinyl functional group; and
2 to 40 parts by weight of ammonium chloride as an antimicrobial agent.

2. The silicone composition for synthetic leather according to claim 1, wherein the secondary coating solution comprises:
100 parts by weight of LSR having vinyl functional groups, being an addition-reaction type silicone, having an average molecular weight of 100,000 to 700,000, a Shore hardness of 30 to 70, and an elongation of 200 to 700%;
5 to 20 parts by weight of a low-viscosity silicone polymer;
0.2 to 60 parts by weight of a silicone curing agent;
0.1 to 60 parts by weight of the platinum catalyst;
0.2 to 15 parts by weight of the reaction retarder; and
2 to 30 parts by weight of a toner.

3. The silicone composition for synthetic leather according to claim 1, wherein the tertiary coating solution comprises:
100 parts by weight of LSR having vinyl functional groups, being an addition-reaction type silicone, having an average molecular weight of 100,000 to 700,000, a Shore hardness of 20 to 80, and an elongation of 200 to 700%;
5 to 50 parts by weight of the low-viscosity silicone polymer having a vinyl functional group;
0.2 to 60 parts by weight of the silicone curing agent having a methyl hydrogen functional group;
1 to 60 parts by weight of the platinum catalyst;
0.2 to 15 parts by weight of the reaction retarder; and
2 to 30 parts by weight of a toner.

4. The silicone composition for synthetic leather according to claim 1, wherein the composition further comprises a surface treatment coating solution prepared by mixing 1 to 15 parts by weight of an ammonium chloride-based antibacterial agent with a conventional surface treatment agent.

5. A method for manufacturing synthetic leather using one or more of the coating solutions according to claim 1, the method comprising:
a step (S1) for coating the primary coating solution onto a release liner at a thickness of 2 to 50 μm, followed by curing and drying the coated layer to form the primary coating layer;
a step (S2) for coating the secondary coating solution onto the primary coating layer formed in step (S1) at a thickness of 10 to 60 μm to form the secondary coating layer;
a step (S3) for coating the tertiary coating solution on the secondary coating layer formed in step (S2) at a thickness of 10 to 80 μm; and
a step (S4) for laminating and compressing a fabric onto the coated surface formed in step (S3), followed by curing and drying.

6. The method of claim 5, wherein the curing and drying in step (S1), step (S2), and step (S4) are each performed at a temperature of 130 to 150° C. for 3 to 5 minutes.

7. The method of claim 5, wherein the fabric in step (S4) is woven from one or more of the following yarns in the order listed: polyester 75-denier 36-filament yarn, 30-denier 12-filament high-shrinkage yarn, and polyester 75-denier 144-filament yarn.

8. The method of claim 5, further comprising a step (SS1) for coating the surface treatment coating solution containing 1 to 15 parts by weight of the ammonium chloride-based antibacterial agent in the conventional surface treatment agent on the primary coating layer after step (S4) at a thickness of 3 to 10 μm to form a surface treatment layer.
